(19) United States
(12) Patent Application Publication
(10) Pub. No.: US 2008/0046400 A1
(43) Pub. Date: Feb. 21, 2008

(54) APPARATUS AND METHOD OF OPTIMIZING DATABASE CLUSTERING WITH ZERO TRANSACTION LOSS

(76) Inventors: Justin Y. Shi, Wayne, PA (US); Suntian Song, Redmond, WA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/776,143

(22) Filed: Jul. 11, 2007

Related U.S. Application Data
(60) Provisional application No. 60/836,462, filed on Aug. 4, 2006.

(51) Int. Cl. G06F 17/30

(52) U.S. Cl. 707/2; 707/E17.046

(57) ABSTRACT

An efficient database cluster system that uses multiple stand-alone database servers with independent datasets to deliver higher processing speed and higher service availability at the same time with zero transaction losses. In one embodiment, a dynamic serializing transaction replication engine with dynamic load balancing for read-only queries is implemented. In another embodiment, a non-stop database resynchronization method that can resynchronize one or more out-of-sync databases without shutting down the cluster automatic database resynchronization process is implemented. In yet another embodiment, an embedded concurrency control language is implemented in the replication engine for precise control of the dynamic serialization engine for optimal processing performance. In yet another embodiment, a zero-downtime gateway failover/failback scheme using a public Internet Protocol (IP) is implemented. In yet another embodiment, a horizontal data partitioning method for load balancing update queries is implemented.

### CROSS REFERENCE TO RELATED APPLICATIONS

This application claims priority from U.S. Provisional Application No. 60/836,462 filed on Aug. 4, 2006, which is incorporated by reference as if fully set forth.

This application is also related to U.S. Pat. No. 6,421,688 entitled “Method and Apparatus for Database Fault Tolerance With Instant Transaction Replication Using Off-The-Shelf Database Servers and Low Bandwidth Networks” by Suntian Song, which is incorporated herein by reference.

### FIELD OF INVENTION

The present invention relates to database management techniques. More particularly, the present invention relates to an apparatus and method for implementing database clustering to deliver scalable performance and provide database services at the same time.

### BACKGROUND

Data replication is an essential service for all electronic commerce and information service applications. FIG. 1 shows a conventional data replication system 50 which includes a primary server 60, a secondary server 70 and a transactions queue 80. Transaction losses may occur if the primary server 60 may unexpectedly fail before all transactions in the queue are replicated.

The conventional data replication system 50 provides data replication services using static serialization methods, via either synchronous or asynchronous protocols.

Static serialization methods require that a primary data copy and a secondary data copy be designated. A data copy may be a copy of a database or a data file or a collection of disk blocks representing a data file. A strict sequential order amongst all concurrent transactions must be established before replication can take place. Maintaining this strict sequential order is essential for data consistency. However, the use of static serialization methods has been proven to be highly inefficient and prone to errors.

When synchronous static serialization methods, (i.e., static serialization methods that use a synchronous (“all of nothing”) protocol), are implemented in the data replication system 50, the overall system performance is limited by the highest possible rate of serial data replication are implemented in the data replication system 50. Each transaction in the queue 80 is first applied to the primary server 60, then applied to the secondary server 70, and is only committed when both the primary server 60 and the secondary server 70 are committed. “Committing a query” refers to acknowledging that the server has received and processed the data request. Synchronous serial replication forces the overall system to operate under the highest possible rate replication on the secondary server. The overall availability of the data replication system 50 is also substantially lower than the availability of a single database server would be, since the failure of either the primary server 60 or the secondary server 70 would cause a transaction to rollback, or the data replication system 50 will completely stop processing transactions in the queue 80 altogether.

When asynchronous static serialization methods, (i.e., static serialization methods that use an asynchronous protocol), are implemented in the data replication system 50, overall system performance is limited by the highest possible rate of serial data replication of the secondary server 70. When a buffer, (i.e., a replication queue), is provided, replicated transactions are temporarily stored until system quiet times. The replication queue is situated “behind” the database transaction queue. The transaction queue records the current transactions yet to be committed on the local server. The replication queue records the transactions that are already committed in the local server but not yet on the secondary server. In all systems that use a serial asynchronous replication method, unless there is a flow-control of the incoming transactions, the buffer will overflow when the primary server 60 processes transactions persistently faster than the serial replication on the secondary database server 70. The primary server 60 and the secondary server 70 cannot ensure synchrony between the primary and secondary data copies, and thus pose the possibility of transaction losses when the replication queue is corrupted unexpectedly before the queued transactions are replicated.

While it is possible to reduce the replication delay to a small value, the strict serial order imposed by these methods places severe limitations on the deliverable performance, ease of management and overall system availability. Unlike the static serialization methods described above, parallel synchronous transaction replication allows for concurrent transactions to be processed by a primary server and a plurality of secondary servers. It is not necessary to maintain the strict sequential order for all of the transactions. Therefore, in theory, parallel synchronous transaction replication can potentially improve performance and system availability at the same time. However, there are serious challenges including data synchronization and non-stop service difficulties. Currently, there is no practical method or apparatus that can ensure identical processing orders replicated onto multiple concurrently running shared-nothing servers. Without such a method or apparatus, race conditions can occur which may cause database lockups and inconsistent data contents. Currently, planned server downtimes are more than twice that of unplanned server downtimes due to the use of replicated systems.

### SUMMARY

The present invention provides an efficient database cluster system that uses multiple stand-alone database servers with independent datasets to deliver higher processing speed and higher service availability at the same time with zero transaction losses. In one embodiment, a dynamic serializing transaction replication engine with dynamic load balancing for read-only queries is implemented. In another embodiment, a non-stop database resynchronization method that can resynchronize one or more out-of-sync databases without shutting down the cluster automatic database resynchronization process is implemented. In yet another embodiment, an embedded concurrency control language is implemented in the replication engine for precise control of the dynamic serialization engine for optimal processing performance. In yet another embodiment, a zero-downtime gateway failover/failback scheme using a public Internet Protocol (IP) is implemented.

In yet another embodiment, a horizontal data partitioning method for load balancing update queries is implemented. In a preferred embodiment of the present invention, multiple database clients connect to a database cluster via a database protocol processing gateway (GW). This gateway implements dynamic transaction serialization and dynamic load balancing for read-only queries. The gateway is also capable of supporting non-stop database resynchronization and other related functions.

There may be a plurality of database servers in the cluster. Each of these servers is initialized with identical database contents and is configured to generate full transaction log in normal operations.

The disclosed dynamic serialization engine, (i.e., database gateway), guarantees all servers are synchronized in data contents in real time. The dynamic load balancing engine can automatically separate stateless read-only queries for load balancing.

A stateless read-only query is a read-only query whose result set is not used in immediate subsequent updates. This is to prevent erroneous updates caused by transient data inconsistencies caused by uneven delays on multiple stand-alone servers.

In such a database cluster, transactions are captured and replicated or load balanced during network transmission of queries. Therefore, the database cluster offers zero transaction loss regardless of multiple database server and gateway failures. This is because if a transaction fails to commit due to database or gateway failures, the application will re-submit it; and if a transaction commits via a database gateway, it is guaranteed to persist on one or more database servers. The database cluster also allows the least intrusive deployment to existing database infrastructures. This is also fundamentally different than conventional transaction replication methods hosted by the database engine.

All servers in the cluster must start with identical data contents. Note that the notion of “identical data contents” is defined as “identical contents if retrieved via the standard database query language.” This allows different servers to store the same data in different storage areas and even in different formats.

In such a database cluster, the reliability of the overall system increases exponentially, since the database service will be available unless all servers crash at the same time. The performance of the database cluster will also exceed that for a single server due to the load balancing effects on read-only and update queries (with partitioned datasets).

The database gateway can be protected from its own failures by using a slave gateway that monitors the master database gateway in real time. In the event of gateway failure, the slave gateway can takeover the master database gateway's network address and resume its duties. Recovering from a failed gateway using the disclosed method requires no cluster down time at all.

In the preferred embodiment, each database server is configured to generate a complete transaction log and have access to a shared network storage device. This ensures that in the event of data failure, out-of-sync servers may be properly resynchronized using dataset from one of the healthy servers.

In the preferred embodiment of present invention, the structured query language (SQL) allows comments. The comments are to be placed in front of each embedded concurrency control statement so that the replication gateway will receive performance optimizing instructions while the database application remains portable with or without using the gateway.

In the preferred embodiment, the performance is enhanced to significantly reduce processing time by load balancing read-only queries and update queries, (through replicated partitioned datasets). These performance gains will be delivered after the transaction load balancing benefits exceed the network overhead.

In the preferred embodiment, the present invention allows synchronous parallel transaction replication across low bandwidth or wide-area networks due to its small bandwidth requirements.

In summary, the advantages of the present invention include the following:
1) Zero transaction loss continuous replication permitting multiple database server or gateway failures;
2) Virtually non-stop database service using any off-the-shelf database server hardware and software;
3) Higher transaction processing performance and higher service availability at the same time; and
4) Synchronous transaction replication using low-bandwidth or wide-area networks.

Implementation of the present invention requires the general knowledge of database and network communication protocols, operating systems and parallel processing principles.

### BRIEF DESCRIPTION OF THE DRAWINGS

A more detailed understanding of the invention may be had from the following description, given by way of example and to be understood in conjunction with the accompanying drawings wherein:

FIG. 1 is a block diagram of a conventional data replication system which includes a primary database server, a secondary database server and a transactions queue;

FIG. 2 is a top-level block diagram of a transaction replication engine used to form a database cluster in accordance with the present invention;

FIG. 3 illustrates the concept of dynamic serialization in accordance with the present invention;

FIG. 4 shows a dual gateway with mutual Internet Protocol (IP)-takeover and public gateway IP addresses in accordance with the present invention;

FIG. 5 illustrates an initial setup for implementing a minimal hardware clustering solution using at least two servers in accordance with the present invention;

FIG. 6 illustrates a situation where one of the two servers of FIG. 5 is shutdown due to a malfunction in accordance with the present invention;

FIG. 7 illustrates a restored cluster after the malfunction illustrated in FIG. 6 is corrected in accordance with the present invention; and

FIG. 8 shows a database server configuration for implementing total query acceleration in accordance with the present invention.

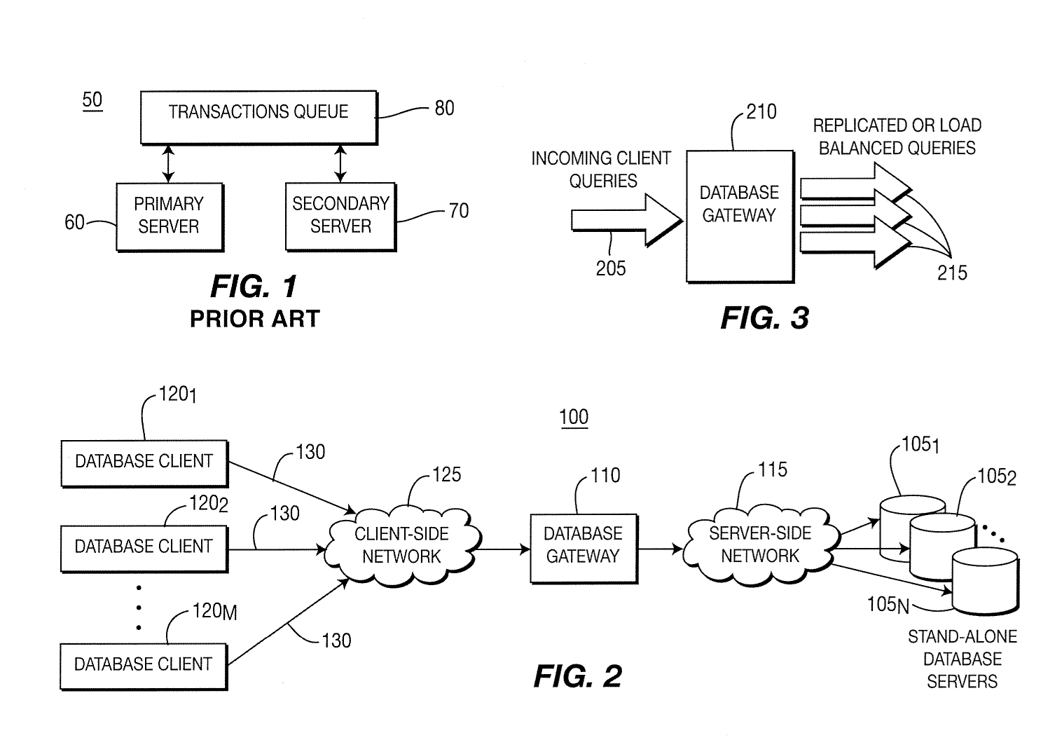

### DETAILED DESCRIPTION OF THE PREFERRED EMBODIMENTS

Hereinafter, the term “update” includes all meanings of “insert”, “update”, and “delete” in the standard SQL language.

The present invention describes the operating principles in the context of database replication. The same principles apply to file and storage replication systems.

The present invention provides high performance fault tolerant database cluster using multiple stand-alone off-the-shelf database servers. More particularly, the present invention provides non-intrusive non-stop database services for computer applications employing modern relational database servers, such as Microsoft SQL Server®, Oracle®, Sybase®, DB2®, Informix®, MySQL, and the like. The present invention can also be used to provide faster and more reliable replication methods for file and disk mirroring systems.

The present invention provides an optimized dynamic serialization method that can ensure the exact processing orders on multiple concurrent running stand-alone database servers. For non-stop service, a coherent practical system is disclosed that may be used to deliver scalable performance and availability of database clusters at the same time.

1. Basic Architecture

FIG. 2 presents a top-level block diagram of a transaction replication engine 100 which is configured in accordance with the present invention. The transaction replication engine 100 forms a database cluster capable of delivering scalable performance and providing database services. In the transaction replication engine 100, a plurality of redundant stand-alone database servers 105₁, 105₂, . . . , 105_{N} are connected to a database gateway 110 via a server-side network 115, and a plurality of database clients 120₁, 120₂, . . . , 120_{M} are connected to the database gateway 110 via a client-side network 125.

The transaction replication engine 100 may host a plurality of database gateway services. All of the database clients 120₁, 120₂, . . . , 120_{M} connect to the database gateway 110 and send client queries 130 for database services. The database gateway 110 analyzes each of the client queries 130 and determines whether or not the client queries 130 should be load balanced, (i.e., read-only and stateless), or dynamically serialized and replicated. Each of the database servers 105₁, 105₂, . . . , 105_{N} may host a database agent (not shown) that monitors the status of the respective database server 105, which is then reported to all related database gateway services provided by the transaction replication engine 100.

The present invention makes no assumptions on either the client-side network 125 or the server-side network 115, which may be unreliable at times. In all possible scenarios, the clustered database servers 105₁, 105₂, . . . , 105_{N} will always outperform a single database server under the same networking conditions.

2. Database Gateway

The database gateway is a service hosted by a reliable operating system, such as Unix or Windows.

A typical server hardware can host a plurality of database gateway services. Each database gateway service represents a high performance fault tolerant database cluster supported by a group of redundant database services.

The minimal hardware configuration of a database gateway service is as follows:
a) Minimum memory size=16 million bytes+16 kilobytes×number of simultaneous client-to-server connections;
b) Minimum disk space=500 million bytes (to host the potential log files); and
c) Minimum network interface card=1.

The hardware configuration can be enhanced to improve the gateway performance. Typical measures include:
a) Use of multiple processors;
b) Use hyper-threading processors;
c) Add more memory;
d) Add more cache; and
e) Use multiple network interface cards.

For large scale applications, multiple independent database gateways can also be used to distribute the gateway processing loads.

2.1 Basic Database Gateway Operations

A database gateway service has a stopped state, a paused state and a running state. A stopped gateway service does not allow any active connections, incoming or existing. A paused gateway service will not accept new connections but will allow existing connections to complete. A running gateway service accepts and maintains all incoming connections and outgoing connections to multiple database servers.

FIG. 3 illustrates the concept of dynamic serialization in accordance with the present invention. Incoming client queries 205 are sequentially transmitted via a gateway 210 using the transmission control protocol (TCP)/IP in the form of interleaving sequential packets. Unlike conventional methods, the dynamic serialization provided by the database gateway 210 occurs without any queuing mechanisms. No pseudo random numbers are introduced, no shared storage or cache is assumed, and no arbitration device is introduced. In particular, the gateway 210 uses selective serialization at the high-level application data communication protocol level, not the TCP/IP level.

Once the client queries 205 are received by the gateway 210, the gateway 210 strips TCP/IP headers revealing the database communication packets. These packets constitute multiple concurrent database connections. “Update” queries are replicated by the gateway 210 to all servers. “Read” queries are distributed or load balanced to only one of the servers. Each connection starts with a login packet and terminates with a close packet. The gateway 210 outputs replicated (i.e., “update”) or load balanced (i.e., “read”) queries 215.

Since the gateway 210 manages all concurrent connections, it is capable of providing dynamic serialization amongst concurrently updated objects. The dynamic serialization algorithm uses the same concept of a semaphore to ensure that a strictly serial processing order is imposed on all servers by the queries concurrently updating the same objects. Concurrent updates on different objects are allowed to proceed in parallel. This is a drastic departure from conventional primary-first methods.

Since serialization necessarily slows down the processing speed, an embedded concurrency control language is designed to let the application programmer to provide optimizing instructions for the serialization engine. Proper use of the concurrency control statements can ensure the minimal serialization overhead, thus the optimal performance.

There are two types of gateways:
a) Replication with dynamic load balancing, or
b) Dedicated load balancer.

Type a) performs transaction replication with dynamic load balancing where read-only queries can be distributed to multiple servers within the same connection.

Type b) performs read-only query distribution by different connections. Thus it provides higher data consistency level than the dynamic load balancing engine.

2.2 Concurrency Control

Gateway concurrency control is accomplished by providing gateway level serialization definitions, or using embedded concurrency control statements (ICXLOCK).

The gateway level serialization definitions are provided at the gateway level for applications that do not have the flexibility to add the embedded concurrency control statements to application source codes. The gateway level serialization definitions include global locking definitions and critical information definitions. There are five global lock definitions: Select, Insert, Delete, Update and Stored Procedures. Each global lock definition can choose to have exclusive, shared or no lock. The critical information definitions identify the stored procedures that contain update queries. They also identify concurrent dependencies between stored procedures and tables being updated.

The embedded concurrency control statements (ICXLOCK) have two lock types: exclusive and shared.

In addition to fine control of dynamic serialization engine, the embedded concurrency control statements are also designed to perform the following:
1) Force dynamic serialization in multi-level gateway replication;
2) Force load balancing on stored procedures and complex queries; and
3) Suppress replication for server-side function activation.

Each embedded statement assumes that the scope of a control statement includes all subsequent queries within the current connection, and each control statement must be sent in a single packet from the application.

2.3 Gateway Working Details

The following pseudo codes include the details of the workflow of the database gateway 210 for processing each incoming client query, (i.e., database communication packet).
30 Setup client connection.
31 Open connections to all members of the database server group.
32 Switch the primary database server to a different server if cannot connect to the primary server.
33 Disable all non-functional database servers.
34 While (not (server_down or error or client_disconnect))
35 Read client query.
36 If encrypted, then decrypt the query.
37 If this is a Login packet then process it so all servers are ready to accept queries. Otherwise return error to the client. Deactivate servers if inconsistent with the primary.
38 If the query is ICXLOCK ON then create a semaphore of corresponding name
39 Elseif the query is ICXNR ON, then set no replication (NR) control
40 Elseif the query is ICXLB ON then set load balancer (LB) control
41 Elseif the query is ICXLOCK OFF then cancel the corresponding semaphore
42 Elseif the query is ICXNR OFF then reset NR control
43 ELseif the query is ICXLB OFF then reset LB control
44 Else parse the query to identify its updating target (table name)
45 If the update target=Null then set LB control if not already set and send query to a server (by load balance heuristic), switch the primary if it is not functional or unreachable, Disconnect if cannot switch.
   Elseif NR is set then send the query only to the primary server. Else wait/set for the corresponding semaphore to clear; send query to all servers, switch the primary if it is not functional or unreachable, Disconnect if cannot switch.
   End If
46 Read the primary server's reply, switch the primary if it is not functional or unreachable. Disconnect if cannot switch.
   If (NR not set) and (LB not set) then wait, receive and compare returns from all servers. If any return status not identical with the primary, disable the corresponding server.
   Else receive and discard replies from non-primary database servers.
48 Log this transmission, if “Packet Log”=True.
49 If “Encryption”=True, then encrypt the returned contents
50 Send the received content to client.
53 End while.
54 Close all connections.
55 Release all resources allocated to this connection.

Line 30 sets up the communication with the client. It then tries to all members of the database cluster (one of them is the primary). Line 31 checks to see if the primary database server can be connected. If the primary database server cannot be connected, then the program tries to locate a backup server 32. The thread exits if it cannot find any usable backup server. Otherwise, it marks all non reachable servers “disabled” and continues to line 34.

Line 34 indicates that the thread enters a loop that only exits when a “server shutdown” or “client_disconnect” signal is received. Other exits will only be at various error spots.

Line 35 reads the client query. If this connection is encrypted, this query is decrypted to yield a clear text 36. Line 37 processes client login for multiple database servers. Line 38 sends the query to all database servers via the query synchronizer 16. Line 38 also includes the database server switching function similar to 31, 32 and 33, if the primary database server becomes unreachable or unstable during the transmission.

Lines 38-43 checks and processes embedded statements.

Line 44 parses the packet to identify a) if this is an update query; and b) if it is an update query, determine its updating target (table name).

Line 45 handles dynamic load balancing, ICXNR (no replication) and replication to all target servers.

Line 46 processes the returned results from the primary and all other servers. Return statuses are check for data consistency.

Line 48 logs this transmission if needed.

Line 49 encrypts the result set if needed.

Line 50 sends the result set to client.

In such a network operating environment, gateway services can also be programmed to deny connection by pre-screening a requester's IP address, a function similar to the firewalls. Other functions can also be included in the gateway processing, such as virus checks, database performance statistics and other monitoring functions.

2.4 Dedicated Load Balancer

A dedicated load balancer is designed to provide connection-based load balanced for read-only database service. A dedicated load balancer differs from the dynamic load balancer in its load distribution algorithm. The dynamic load balancer distributes read-only queries within the same client connection. The dedicated load balancer distributes read-only queries by client connections. The dedicated load balancer can safely service business intelligence applications that require temporary database objects. Dynamic load balancing is not appropriate for read-only applications that require temporary database objects. The dedicated load balancer can offer higher data consistency than dynamic load balancer since queries in each connection are processed on the same database target.

The dedicated load balancer can use any heuristic algorithms to decide the most likely next server target, such as Round Robin, least waiting connections, fastest last response and least waiting queries.

3. Concurrency Control Language

The concurrency control language contains three types of constructs:

a) Lock control: ICXLOCK.

b) Load balance control: ICXLB.

c) Replication control: ICXNR.

3.1 Set ICXLB

This statement is designed to force load balancing of complex queries or stored procedures.

An example of ICXLB statements is as follows: —
Set ICXLB on
exec sp_CheckCount
Set ICXLB off

The “—” signs are standard SQL comment marks. They are to maintain the application's portability that the same source will work with and without gateway involved.

3.2 Set ICXLOCK

This statement is designed for precise serialization controls for better performance.

There are also two kinds of locks: exclusive (1) and shared (0).

For example:
set ICXLOCK on Stocks 1
update Stocks set . . .
set ICXLOCK off Stocks 1

This example shows how to serialize the table “stocks” exclusively. The exclusive lock does not allow any concurrent accesses to the locked table.

Alternatively, the following statement:
set ICXLOCK on Stocks 0
   locks the table “Stocks” in shared-lock mode. This permits concurrent read accesses on the table “Stocks.”

There are three levels of serialization: row level, table level and multiple objects.

3.2.1 Row-Level Lock

A row-level lock requires a string that can uniquely identify a single row as the serialization target (locking). For example:
set ICXLOCK on A24 1
INSERT INTO TstContact(Name) VALUES (‘% c’)″,‘A’+nID)
set ICXLOCK off A24 1
   where “A24” is obtained from evaluating ‘A’+nID at runtime, the unique row in the table TstContact that may be updated concurrently.

3.2.2 Table-Level Lock

A table-level lock requires a table name as the serialization target. The previous example with the table Stocks illustrates such an application.

3.2.3 Multi-Object Lock

A multi-object lock requires a string that is going to be used consistently by all applications that may update any single object in the protected multi-object set. For example, if the update of row B is dependent on the result of updating row A, and both rows may be updated concurrently, then in all applications the updates should include the following:
ICXLOCK ON rowAB 1
update rowA
ICXLOCK OFF rowAB 1
ICXLOCK ON rowAB 1
update rowB
ICXLOCK OFF rowAB 1

If an application is programmed consistently using ICXLOCK statements, then the global locks can be all set to NONE. This can deliver the optimal runtime performance.

3.3 Set ICXAUTOLB On/Off

This statement lets the application to turn the dynamic load balancing function on and off. This statement can prevent errors caused by the dynamic load balancing engine that somehow wrongly balanced stateful read-only queries. The errors are reported as Status Mismatch Error when a few servers return different status than the current primary.

3.4 Set ICXNOLOCK On/Off

This statement allows precise control of specific object. For example, if all updates to a table are handled by a single long hanging connection, it is then impossible to have other concurrent reads to this table. This can be resolved by wrapping “set ICXNOLOCK on” around the read-only queries to allow full concurrent accesses.

3.5 Set ICXNR On/Off

This statement suppresses the replication of wrapped queries. This is useful in activating server-side functions that should not be (replicated) executed on all servers in the cluster, such as a stored procedure that performs a backup, or sends email or updates to an object that are not in the cluster.

Using this statement to control the replication effect has the advantage of automatic fail over protection. The application will function as long as there is a single SQL Server in the cluster.

4. Automatic Database Resynchronization

When a database server is deactivated for any reason, its contents are out-of-sync with the rest of the servers in the cluster. It is in general very difficult to bring this out-of-sync server back in sync with the rest of the servers in the cluster without shutting down the cluster.

This section discloses a process that can bring one or more out-of-sync database servers back in-sync with the rest of servers in the cluster without stopping cluster service.

Assuming a user defined scan interval=S. We further assume following database setup conditions:
1 Each server is configured to generate full transaction log.
2 Each server runs under an account that can have the network access permissions.
3 There is a network-shared path with sufficient space where all servers can read and write backup files.

The following process will ensure a seamless resynchronization for one or more out-of-sync servers to recover:
a) Start full backup process from the current primary server in the cluster onto the shared network path.
b) Initiate database restore (one or more servers) using the dataset stored on the shared network path when the backup is finished.
c) Restore the current transaction log (one or more servers).
d) After S seconds, scan the transaction log to see if any new updates.
e) If the transaction log contains new updates, then goto (c).
f) Else pause database gateway, scan the transaction log again. If any new updates, then goto (c), otherwise activate the corresponding server(s).

As long as S is greater than the sum of communication and command interpretation delays, the above procedure can automatically resynchronize one or more servers without shutting down the cluster. If the resynchronization process cannot terminate due to sustained heavy updates, pause the database gateway, disconnect all connections to force the resynchronization process to terminate and automatically activate the resynchronized servers.

In this description, the knowledge of regular database backup and restore knowledge is necessary to understand the above disclosed steps.

4. Non-stop Gateway Recovery

Using the methods disclosed in this invention, the database gateway is the single-point-failure since the cluster service will become unavailable if the gateway fails.

IP-takeover is a well-known technique to provide protection against such a failure. IP-takeover works by setting a backup gateway monitoring the primary gateway by sending it periodic “heart beats”. If the primary fails to respond to a heart beat, the backup gateway will assume that the primary is no longer functioning. It will initiate a shutdown process to ensure the primary gateway to extract its presence on the network. After this, the backup gateway will bind the primary gateway's IP address to its local network interface card. The cluster service should resume after this point since the backup gateway will be fully functioning.

Recovering a failed gateway involves recovering both gateways to their original settings. Since it involves forcing the backup gateway to release its current working IP address, it requires shutting down the cluster service for a brief time.

In accordance with the present invention, a Public Virtual IP address provides seamless gateway recovery without cluster downtime. The Public Virtual IP address eliminates administrative errors and allows total elimination of service downtime when restoring a failed gateway.

The idea is to have a public virtual IP for each gateway instance (IPp) while allowing each server to keep its permanent physical IP address. Servers can be programmed to reboot automatically without fearing IP conflicts.

4.1 Single Gateway with a Backup

For a single gateway with a backup, the public gateway IP address can result in absolute zero downtime when restoring gateway server.

This is done by setting both gateways to take over the single public gateway IP address (only one succeeds).

When the current primary fails, the backup gateway will take over the public gateway IP address. Operation continues. Restoring the failed gateway requires a simple reboot of the failed gateway which is already programmed to take over the public gateway IP address. This process can be repeated indefinitely.

4.1 Dual Gateway on Dual Servers

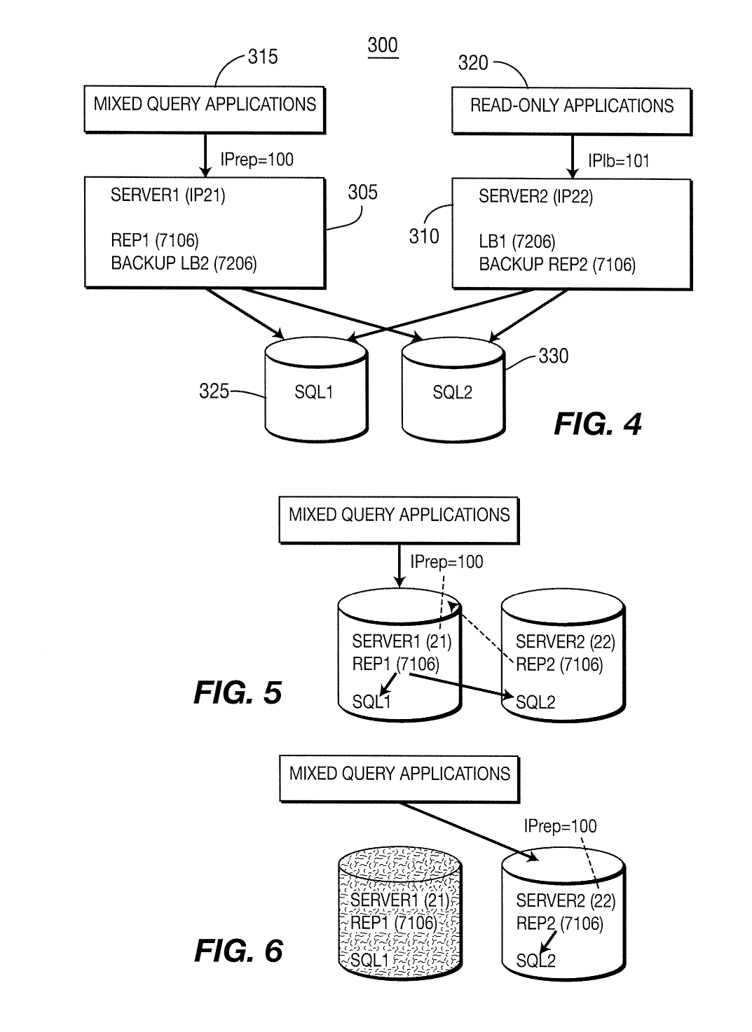

FIG. 4 shows a dual gateway configuration 300 with mutual IP-takeover and public gateway IP addresses in accordance with the present invention. The dual gateway configuration 300 eliminates downtimes caused by administrative errors.

Referring to FIG. 4, there are two IP addresses: IPrep=100 and IPlb=101. Initially, IP 21 is bound to IPrep 100 and IP 22 is bound to IPlb 101. Applications 315, 320 are connected directly to IPrep and IPlb. Rep1 and Rep2 are configured to takeover IPrep=100 and LB1 and LB2 are configured to take over IPlb 101. If Server1 crashes, Rep2 will initiate an IP-takeover process and bind IP address 100 to Server2 IP 22. At this time, Server2 should have three IP addresses bound to its network interface card: 22, 100 and 101. Cluster operation then continues.

Restoring Server1 requires only two steps:
a) Boot Server1. Rep1 will attempt to takeover IPrep=100 and LB2 will attempt to takeover IPlb=101. Neither can happen since both IP address are active.
b) Make Rep2 to restore standby. This will cause Server2 to release the IP address 100.

Rep1 should then automatically takeover IP address 100. The cluster operation continues.

The process for restoring Server2 is symmetrical. These processes can be repeated indefinitely.

4.3. Zero Hardware Configurations

Zero hardware refers to configurations that co-host a synchronous replication gateway service with an SQL server. This eliminates the need for dedicated server hardware for the replication/resynchronization services.

The operating principle for zero hardware configurations is identical to dedicated gateway servers. There is, however, overall cluster availability difference since the crash of a single server can potentially bring down the cluster service and a SQL Server. In comparison, using dedicated gateway servers does not have this problem.

FIG. 5 depicts an example of an initial setup procedure in accordance with the present invention. In examples illustrated in FIGS. 5-7, the public gateway IP address (IPrep) is 100. Both gateways Rep1 and Rep2 are configured to take over the public gateway IP address 100. Rep1 did the first takeover. Rep2 is standing by.

FIG. 6 shows the situation when Server 1 is shutdown for malfunction of Rep1, SQL1 or Server 1 hardware. Thus, the cluster is running on a single SQL and a single gateway instance.

Restoring Server1 involves the following two steps:

a) Bring Server1 online. Rep1 should be settled in normal “slave” mode, ready to take over IP address 100.

b) Use the automatic resynchronization process to resync SQL1 with SQL2.

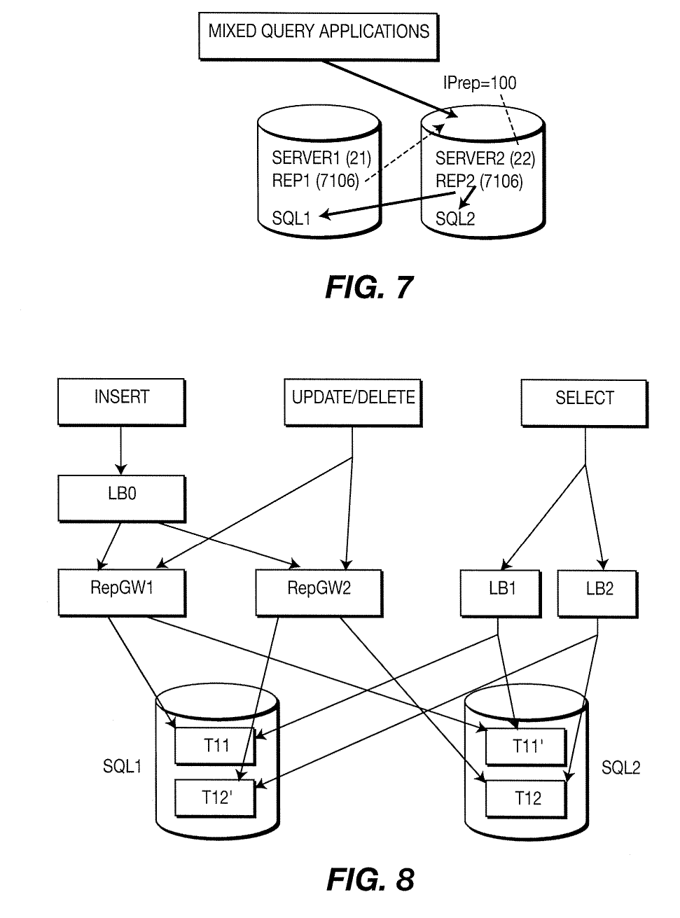

FIG. 7 shows the restored cluster. The Server2 failure will eventually bring the cluster to the state shown in FIG. 5. The cluster state will alternate between the configurations of FIGS. 5 and 7 indefinitely unless both of the servers fail at the same time. Adding additional SQL Servers into the restored cluster will only complicate step (b) in the recovery procedure.

This section illustrates three typical configurations using the public gateway IP addresses for gateway fail over. The overall performance and availability measures between these configurations differ greatly. The actual choice rests with the application designer.

There are also other configurations that can use the public gateway IP address concept. The same principles apply.

5. Data Partitioning for Load Balancing Update Queries

5.1 Background

Update queries include update, delete and insert SQL statements. The processing time for these statements grows proportionally as the dataset size. Update time increases significantly for tables with indexes, since each update involves updating the corresponding index(es) as well.

Table partitioning is an effective performance enhancement methodology for all SQL queries. Partitioned tables are typically hosted on independent servers and their datasets are significantly smaller in size, therefore higher performance can be expected. In literature, these are called federated database, distributed partitioned view (DPV), horizontal partitioning or simply database clustering.

However, since existing database partitioning systems do not support synchronous replication natively, hosting a single table onto multiple servers necessarily reduces the availability of the overall system since the failure of any single server will adversely affect the availability of the entire cluster.

The disclosed synchronous parallel replication method is ideally suited in solving this problem. This section discloses a simple method for deliver higher scalability for update queries while maintaining the same availability benefits.

5.2 Reducing Processing Time for Update Queries

We will partition heavily accessed or oversized tables horizontally in order to reduce its processing time. We then replicate the partitions using the disclosed synchronous parallel replication method. The result is a SQL Server cluster with approximately the same disk consumption compared to without partitioning.

This new cluster can provide load balancing benefits for update queries while delivering availability at the same time.

Note that as with all horizontal partitioning technologies, application re-programming is necessary if the tables contain identity column or unique key constraints.

5.3 Explanation by Example

FIG. 8 shows an example of a database cluster system for implementing total query acceleration in accordance with the present invention. The system includes a first replicator gateway RepGW1, a second replicator gateway RepGW2, a first load balancer LB0, a second load balancer LB1, a third load balancer LB2, a primary database server SQ1 and a secondary database server SQ2.

In accordance with present invention, the first replicator gateway RepGW1 and the second replicator gateway RepGW2 receive UPDATE SQL statements. The first load balancer LB0 receives INSERT SQL statements and distributing the received INSERT SQL statements to the first replicator gateway RepGW1 and the second replicator gateway RepGW2. The primary database server SQL1 hosts a first partitioned data table T11 and a backup copy of a second partitioned data table T12′. The secondary database server SQL2 hosts the second partitioned data table T12 and a backup copy of the first partitioned data table T11′. The second load balancer LB1 and the third load balancer LB2 receives SELECT SQL statements. The second load balancer LB1 distributes the received SELECT SQL statements to the T11 and T11′ data tables. The third load balancer LB2 distributes the received SELECT SQL statements to the T12′ and T12 data tables. The first replicator gateway RepGW1 and the second replicator gateway RepGW2 replicate the INSERT and UPDATE SQL statements in the data tables T11, T11′, T12′ and T12.

A single table T1 is partitioned and hosted on the primary database server SQL1 and the secondary database server SQL2. By horizontal partitioning table T1, two tables are generated: T11+T12.

For higher availability, the two servers SQL1 and SQL2 are cross-replicated with backup copies of each partition: T11′ and T12′, as shown in FIG. 8. The total consumption of disk space of this configuration is exactly the same as a production server with a traditional backup.

A replicator gateway is used for each partition. The first replicator gateway RepGW1 is responsible for T11 and T11′. The second replicator gateway RepGW2 is responsible for T12 and T12′. The first load balancer LB0 is placed in front of the replicator gateways RepGW1 and RepGW2 to distribute INSERT queries to the first replicator gateway RepGW1 and the second replicator gateway RepGW2. A second load balancer LB1 is used to distribute SELECT queries to the partitions T11 and T11′. A third load balancer LB2 is used to distribute the SELECT queries to the partitions T12 and T12′. The first replicator gateway RepGW1 cross-replicates T11 on SQL1 and on the SQL2 as T11′. The second replicator gateway RepGW2 cross-replicates T12 on SQL1 and on SQL2 as T12′.

As shown in FIG. 8, the cross-replicated partitions of table T1=T11+T12, where the two partitions:

T11=T11|T11′ and T12=T12|T12′.

These partitions are the basis for delivering high availability and higher performance at the same time.

5.3.1 INSERT Acceleration

All INSERT queries go directly into the first load balancer LB0, which distributes the inserts onto the first replication gateway RepGW1 and the second replicator gateway RepGW2. Since the target dataset sizes are cut approximately in half, assuming equal hardware for both SQL servers, one can expect 40-50% query time reduction.

Server crashes are protected by the replication and load balancing gateways. No coding is necessary for fault tolerance.

The use of the first load balancer LB0 should be controlled such that rows of dependent tables are inserted into the same partition. Since a dedicated load balancer will not switch target servers until a reconnect, the programmer has total control over this requirement. A small modification is necessary. The new load balancer will first pull the statistics from all servers and distribute the new inserts to the SQL Server that has the least amount of data.

5.3.2 Accelerated UPDATE (or DELETE)

For high performance applications, each UPDATE (or DELETE) query should initiate two threads (one for each partition). Each thread is programmed to handle the “Record Not Exist (RNE)” errors.

For tables with unique-key property, assuming P target servers, there are three cases:
1) 1×RNE. Valid UPDATE and valid DELETE.
2) P×RNE. UPDATE error (target not found) and DELETE error (target not found).
3) k×RNE, 1≦k≦P. UPDATE (and DELETE) inconsistency found. The gateway should deactivate all servers that did not return RNE minus one.

For non-keyed tables, the thread proceeds with all updates (and deletes) regardless RNE errors.

For the configuration shown in FIG. 8, since the dataset size is approximately halved, assuming equal hardware for both SQL Servers, one can expect 40-50% time reduction.

Server crash is protected by RepGW1 and RepGW2. Therefore, the above procedure should execute regardless server crashes.

5.3.3 Accelerated SELECT

For high performance applications, each SELECT query should also initiate two threads, one for each partition (LB1 and LB2).

There are two steps:
a) If the query does not contain JOIN, let each thread execute the query against its own primary partition in parallel. Otherwise, generate two complement queries one for each partition; and execute in the two threads in parallel.
b) After both threads complete, conduct post-processing as follows:
   1) If the query is simple SELECT, return the ordered (if required) union of all result sets.
   2) If the query uses aggregate function, such as MAX, MIN, AVG with “groupby”, “having” and “in” properties perform proper post operations and return the correct result.
   3) If the query involves time or timestamp, return the latest value.

Step (a) needs further explanation since JOIN requires at least two tables. Let us now assume the following:
1 Two tables in the database: T1 and T2
2 Two horizontal partitions. This gives four tables T1=T11+T12 and T2=T21+T22. The two partitions are: P1=T11+T21 and P2=T12+T22.
3 Two SQL Servers: SQL1 and SQL2. SQL1 hosts P1 and P2′. SQL2 hosts P2 and P1′.

For a query T1∩T2=(T11∩T21)^{P1}+(T11∩T22)^{C1}+(T12∩T21)^{C2}+(T12∩T22)^{P2}, where C1 and C2 are the two complements.

Each complement draws its source tables from both partitions hosted on the same server. Therefore, for SQL1, there should be two sub-queries: (T11∩T21)^{P1}+(T11∩T22)^{C1}. Similarly, SQL2 should receive (T12∩T21)^{C2}+(T12∩T22)^{P2}. Results of these queries should be collected and returned to the application.

Since the dataset size has been cut approximately in half and all computations are done in parallel, assuming equal hardware for both servers, the SELECT performance should also improve for up to 50% reduction in query processing time.

Note that the partitioned tables should have a consistent naming convention in order to facilitate the generation of complement sub-queries.

Other changes may also be necessary. Stored procedures and triggers that update tables should be revised to update all related partitioned tables on the same SQL Server. It should also be considered to convert the stored procedures to be client-side functions to take advantage of the performance advantages offered by the new cluster automatically. Foreign keys involved in the partitioned tables might need to be converted. However, if correct INSERT logic is executed in producing the entire dataset, no conversion is necessary. Data transformation packages that update tables must also be revised to update all partitions via RepGW1 and RegGW2.

SQL Server crash is protected by LB1 and LB2. Therefore, the above procedure should always return the correct results until the last SQL Server standing.

5.4 Availability Analysis

As shown in FIG. 8, each SQL Server holds the entire dataset. Therefore, if any subset of the SQL Servers crashes, the cluster service will still stay up but running at a reduced speed. In general, the cluster can sustain P-1 SQL Server crashes where P>=2.

Replicator gateways in a non-partitioned cluster may also be protected by deploying two or more dedicated “Gateway Servers” (GS). Depending on the production traffic requirements, each GS can host a subset or all of the five gateway instances. A slave GS can be programmed to takeover the primary GS operation(s) when the primary fails.

5.5 Scalability Analysis

Adding a new server into the cluster allows for adding a new partition. Likewise, adding a partition necessarily requires a new server. Each addition should further improve the cluster performance.

In this design, the number of partitions=the number of SQL Servers=the number of replication and load balancing gateways. The only growing overheads are at the multiplexing (MUX) and de-multiplex (DEMUX) points of query processes for INSERT, UPDATE/DELETE and SELECT. Since the maximal replication overhead is capped by the number of bytes to be replicated within a query and the maximal processing time difference amongst all SQL Servers for UPDATE queries, it is easy to see that unless the time savings in adding another partition is less than the maximal replication overhead, while keep the same availability benefits, the expanding system should continue to deliver positive performance gains.

Generalization for UPDATE and SELECT processes for P>2 are straightforward. The INSERT process needs no change due to the use of a dedicated load balancer.

For UPDATE, DELETE and SELECT queries, since query processing for the logical table and for its horizontal partitions is well defined, there is a clear template for programming. Therefore automated support is possible to ease application re-programming.

5.6 SQL Server and Gateway Recovery Downtime Analysis

The failure of an SQL server is automatically supported by the configuration shown in FIG. 2. A crashed SQL server may be seamlessly returned to back to cluster service even if the datasets are very large.

In accordance with the present invention, since each server holds the entire (partitioned) dataset, the resynchronization process can be used for data re-synchronization without shutting down the cluster.

Similarly, the failure of a gateway is protected by either an IP-takeover, (for a local area network (LAN)), or a domain name service (DNS)-takeover, (for a wide area network (WAN)). Recovering from any number of crashed gateway servers (GSs) in any networking environment requires zero cluster downtime using a streamlined gateway recovery procedure implemented in accordance with the present invention.

5.7 Cluster Maintenance

Performance Tuning

The partitioned datasets can become uneven in size over time. Scheduled maintenance then become necessary to re-balancing the partition sizes.

Expanding the Cluster

Adding a partition refers to adding a database server. This may be performed by using an automatic resynchronization method to put current data into the new server, and adjusting the gateways so that the current primary partitions on the new server are empty. All existing partitions are non-primary partitions. The load balancer LB0 will distribute new inserts into the new server, since it is the least loaded for the new empty table partitions. The replication gateways will automatically replicate to other servers in the cluster with the new data.

Contracting the Cluster

Removing a server involves resetting the primary partitions where the primary table partition(s) of the removed server are be assumed by another server in the cluster.

### Preferred Embodiment

In accordance with a preferred embodiment, the present invention includes at least two gateways connected to a client-side network and a server-side network. Each of a plurality of database in a cluster has an agent installed. The agent reports local database engine status to all connected gateways. The local status includes truly locally occurred events and events received from a controlling gateway, such as “server deactivation.” For read-only applications that require high qualify data consistency, a dedicated load balancer may be used in conjunction with replication/dynamic load balancing gateways.

### Alternative Embodiments

Due to varying application requirements and hardware configurations, there are numerous alternative embodiments of the present invention.

In one alternative embodiment, a zero-hardware configuration is provided where gateway services are hosted on database servers. This is suitable for low cost implementations but suffers from potential performance and availability bottleneck.

In another alternative embodiment, multiple gateway services are hosted on the same server hardware. This provides ease of management of gateway servers and low cost deployment. There are two possibilities: cross hosting and parallel hosting. In cross hosting where applications require one replication gateway and one dedicated load balancer, two hardware servers may be configured to cross host these services. This provides the best hardware utilization. Gateway recovery requires a brief cluster downtime. In parallel hosting, a pair of gateway servers consisting of one master server and a slave server host the same set of gateway services. This configuration is not as efficient as the above configuration in terms of hardware usage. It does, however, implement the zero down time feature when recovering from a failed gateway.

In yet another alternative embodiment, one server hardware is provided for each gateway service. Since the gateway runs as a service, it can be installed on a dedicated server or sharing server with other services. This is suitable for applications with very high usage requirements.

In yet another alternative embodiment is to have multiple gateway servers to serve the same cluster in order to distribute the gateway processing loads.

In yet another alternative embodiment, multiple gateways cross replicate to each other. This is referred to as a “multi-master configuration”. This configuration will incur higher processing overhead but allows concurrent updates in multiple locations.

In yet another alternative embodiment, the dynamic serialization approach is adapted to disk or file mirroring systems. This is different than the existing mechanisms, where the updates are captured from the primary system in strictly serialized form, and concurrent updates will be allowed synchronously if they do not update the same target data segments. Data consistency will still be preserved since all concurrent updates to the same object will be strictly serialized. This adaptation allows a higher degree of parallelisms commonly exist in modem multi-spindle storage systems.

Any combination of the above mentioned alternative embodiments is possible in practice.

### ADVANTAGES

The present invention provides a unique set of novel features that are not possible using conventional systems. These novel features include:
1) Drastic reduction of database planned and unplanned downtimes.
2) Zero loss continuous transaction protection.
3) High performance and high availability at the same time. The present invention uses the minimal replicated data for enhanced reliability. It also allows read-only and update load balancing for improved performance.
4) Remote synchronous parallel replication possible.
5) Cost effective. Application of the present invention does not require changes in data access programs nor modifications to the database servers. The database gateway can be built using entirely low-cost commodity computer parts.

### OPERATION

In practice, one will first examine and identify the database update patterns. Attention should be paid to programs that using different methods updating the same object. If such instance is found, application must be revised to include proper embedded concurrency control statements to ensure data consistency.

For canned applications, if global locks and critical information definitions cannot eliminate data inconsistencies, the above situation should be highly suspected.

For applications with high percentage of read-only queries, the use of embedded concurrency control statements is ideal for optimized update performance.

For applications with high percentage of updates or the data size is very large, data partition should be considered.

In normal operations, the administrator can perform updates to any number of servers in the cluster without shutting down the cluster. The cluster can also be expanded or contracted without stopping service.

Except for restore back-in-time requirements, the traditional backup/restore duties are no longer necessary for such a cluster since there are multiple copies of identical data online at all times.

### CONCLUSION, REMIFICATIONS AND SCOPE

The present invention discloses detailed instructions for the design, implementation and applications of a high performance fault tolerant database middleware using multiple stand-alone database servers. The designs of the core components, (i.e., gateway, agent and control center), provide the following advantages over conventional methods and apparatus.
1) The present invention eliminates database downtimes including planned and unplanned downtimes.
2) The present invention enables higher performance using clustered stand-alone database servers.
3) The present invention allows on-line repair of crashed database servers. Once a server crash is detected, the database gateway will automatically disallow data access to the crashed server. Database administrators should still be able to reach the server, if the operating system is still functioning. On-line repair may consist of data reloading, device re-allocation and database server reinstallation even operating system reinstallation without affecting the on-going database service.
4) The present invention allows more time for off-line repair of crashed database servers. If a crash is hardware related, the crashed database server should be taken off-line. Off-line repair can consist of replacing the hardware components to replacing the entire computer. Application of the present invention gives the administrators more time and convenience for the repair since the database service is not interrupted while the off-line repair is in progress.
5) The present invention provides more protection to critical data than direct database access. The database gateway's network address filtering function can deny data access from any number of predetermined hosts. This can further filter out undesirable data visitors from the users that are allowed access to the network.
6) The present invention provides security when using Internet as part of the data access network. The database gateway encryption function allows data encryption on all or part of the data networks.
7) The present invention is easy to manage. Even though the present invention uses multiple redundant database serves, management of these servers is identical to that of a single database server through the database gateway, except when there is a crash. That means that one may define/change/remove tables, relations, users and devices through the database gateway as if there is only one database server. All functions will be automatically replicated to all database servers at the same time.
8) Generalized use of the present invention can lead to the development of globally distributed high performance data systems with high data reliability at the same time.
9) The present invention has hardware requirements which allow the use low-cost components. Thus it provides incentive for manufacturers to mass-produce these gateways at even lower costs.
10) The network requirements of the present invention allow the use of low bandwidth networks. This suits perfectly to global electronic commerce where many areas in the world still do not yet have high-speed networks.

Although the features and elements of the present invention are described in the preferred embodiments in particular combinations, each feature or element can be used alone or in various combinations with or without other features and elements of the present invention.

What is claimed is:

1. A method of processing client queries comprising:
(a) receiving a plurality of client queries that are sequentially transmitted using a transmission control protocol (TCP)/Internet protocol (IP) in the form of sequential query packets that constitute multiple concurrent database connections;
(b) replicating each particular query packet onto a plurality of stand-alone database servers if the particular query packet is a data changing query packet; and
(c) distributing or load balancing the particular query packet by sending the particular query packet to only one of the plurality of stand-alone servers if the particular query packet is not a data changing query packet.

2. The method of claim 1 wherein the data changing query packet is an UPDATE query packet.

3. The method of claim 1 wherein the data changing query packet includes a call for activating a stored procedure that contains at least one data changing query.

4. The method of claim 1 wherein the data changing query packet is an INSERT query.

5. The method of claim 1 wherein the data changing query packet is a DELETE query packet.

6. The method of claim 1 further comprising:
stripping TCP/IP headers from the client queries to reveal query packets.

7. The method of claim 1 further comprising:
dynamically serializing concurrent data changing query packets or stored procedures with potential access conflicts for synchronous replication onto a plurality of stand-alone database servers; and
deactivating any server that cannot commit to the exact same data change.

8. The method of claim 1 further comprising:
intercepting embedded concurrency control instructions transmitted along with each query packet to control query replication, load balancing or dynamic serialization.

9. A database cluster comprising:
(a) a database gateway configured to receive a plurality of client queries that are sequentially transmitted using a transmission control protocol (TCP)/Internet protocol (IP) in the form of sequential query packets that constitute multiple concurrent database connections; and
(b) a plurality of stand-alone database servers, wherein each particular query packet is replicated onto the plurality of stand-alone database servers if the particular query packet is a data changing query packet, and the particular query packet is distributed or load-balanced by sending the particular query packet to only one of the plurality of stand-alone servers if the particular query packet is not a data changing query packet.

10. The database cluster of claim 9 wherein the data changing query packet is an UPDATE query packet.

11. The database cluster of claim 9 wherein the data changing query packet includes a call for activating a stored procedure that contains at least one data changing query.

12. The database cluster of claim 9 wherein the data changing query packet is an INSERT query packet.

13. The database cluster of claim 9 wherein the data changing query packet is a DELETE query packet.

14. The database cluster of claim 9 wherein TCP/IP headers are stripped from the client queries to reveal query packets.

15. The database cluster of claim 9 wherein concurrent data changing query packets or stored procedures with potential access conflicts are dynamically serialized for synchronous replication onto all of the servers, and any server that cannot commit to the exact same data change is deactivated.

16. The database cluster of claim 9 wherein the database cluster uses an embedded concurrency control language processor that creates a dynamic serialization object before each data changing query packet is received, and destroys the object after the data changing query packet is processed on all targets.

17. The database cluster of claim 9 wherein the database cluster uses an embedded concurrency control language processor that controls a dynamic locking function.

18. The database cluster of claim 9 wherein the database cluster uses an embedded concurrency control language processor that controls load balancing.

19. The database cluster of claim 9 wherein the database cluster uses an embedded concurrency control language processor that controls query replication.

20. In a database cluster including a database gateway, at least one active database server and one or more deactivated database servers, whereby each of the database servers is configured to generate a full transaction log, a method of automatically resynchronizing the database servers before the deactivated database servers are reactivated, the method comprising:
(a) performing a full backup from one active database server to generate a dataset that is stored onto a network-shared path accessible by all of the database servers;
(b) restoring databases onto the deactivated database servers using the dataset when the full backup is completed;
(c) performing a transaction log backup onto the dataset after a predetermined delay to incorporate any new updates;
(d) loading the transaction log onto the deactivated database servers;
(e) repeating steps (c) and (d) until there are no more new updates;
(f) pausing the database gateway;
(g) disconnecting all clients;
(h) performing a final transaction log backup onto the dataset;
(i) initiate a database restore using the dataset when the final transaction log backup is finished; and
(j) reactivating the deactivated database servers.

21. The method of claim 20 further comprising:
(k) if a high rate of new updates causes step (e) to be repeated more than a predetermined number of times, automatically implementing steps (c)-(j) after pausing the database gateway and disconnecting all query connections.

22. In a database cluster including a first database gateway server associated with a first physical server Internet protocol (IP) address and a second database gateway server associated with a second physical server IP address, wherein each of the database gateway servers is configured to take over a public gateway IP address while the other database gateway server is standing by, a method of restoring a database gateway server that malfunctioned without stopping cluster service, the method comprising:
(a) determining that the database gateway server having the public IP malfunctioned by sending period heart beats;
(b) deactivating the malfunctioning database gateway server for repair;
(c) the other one of the database gateway servers taking over the public gateway IP address by binding the public gateway IP address to its physical server IP address; and
(d) when bringing the malfunctioned database gateway server online after repair, setting the repaired database gateway to monitor and takeover the Public IP.

23. A method of parallel processing data changing queries that include UPDATE, DELETE and INSERT, and SELECT structured query language (SQL) statements in a database cluster system including a primary database server and a secondary database server, the method comprising:
(a) horizontal partitioning a data table T1 to generate a first partitioned data table T11 that is hosted in the primary database server and a second partitioned data table(s) T12 that is hosted in the secondary database server(s);
(b) hosting a backup copy of first partitioned data table T11′ in the secondary database server;
(c) hosting a backup copy of the second partitioned data table T12′ in the primary database server;
(d) replicating the UPDATE, DELETE and load balanced INSERT SQL statements to the data tables T11, T11′, T12′ and T12; and
(e) load balancing the SELECT and INSERT SQL statements to the data tables T11, T11′, T12′ and T12.

24. The method of claim 23 wherein the database cluster system further includes a first replicator gateway that is responsible for the first partitioned data table T11 hosted in the primary database server and the backup copy of the first partitioned data table T11′ hosted in the secondary database server.

25. The method of claim 23 wherein the database cluster system further includes a second replicator gateway that is responsible for the second partitioned data table T12 hosted in the secondary database server and the backup copy of the second partitioned data table T12′ hosted in the primary database server.

26. A database cluster system for parallel processing data changing queries that include UPDATE, DELETE and INSERT, and SELECT structured query language (SQL) statements, the system comprising:
(a) a plurality of replicator gateways configured to receive UPDATE and DELETE SQL statements;
(b) a first load balancer configured to receive INSERT SQL statements and distribute the received INSERT SQL statements to the replicator gateways;
(c) a primary database server configured to host a first partitioned data table T11 and a backup copy of a second partitioned data table T12′;
(d) at least one secondary database server configured to host the second partitioned data table T12 and a backup copy of the first partitioned data table T11′;
(e) second and third load balancers configured to receive SELECT SQL statements, wherein the second load balancer is further configured to distribute SELECT SQL statements to the T11 and T11′ data tables, the third load balancer is further configured to distribute the received SELECT SQL statements to the T12′ and T12 data tables, and the replicator gateways are further configured to replicate DELETE, UPDATE and load balanced INSERT SQL statements in the data tables T11, T11′, T12′ and T12.

27. The system of claim 26 wherein one of the replicator gateways is responsible for the first partitioned data table T11 hosted in the primary database server and the backup copy of the first partitioned data table T11′ hosted in the secondary database server.

28. The system of claim 26 wherein at least one of the replicator gateways is responsible for the second partitioned data table T12 hosted in the secondary database server and the backup copy of the second partitioned data table T12′ hosted in the primary database server.

29. The system of claim 26 wherein the first, second and third load balancers expand their target based on the number of secondary database servers.
